(19) United States
(12) Patent Application Publication
(10) Pub. No.: US 2015/0326082 A1
(43) Pub. Date: Nov. 12, 2015

(54) SINGLE-PHASE INDUCTION MOTOR

(71) Applicant: Whirlpool S.A., Sao Paulo SP (BR)

(72) Inventors: Flavio J.H. Kalluf, Joinville (BR); Aleandro Amauri de Espindola, Joinville (BR)

(73) Assignee: Whirlpool S.A., Sao Paulo SP (BR)

(21) Appl. No.: 14/646,575

(22) PCT Filed: Nov. 26, 2013
(86) PCT No.: PCT/BR2013/000509

§ 371 Date: May 21, 2015

(30) Foreign Application Priority Data
Nov. 26, 2012 (BR) 10 2012 029983.6

(51) Int. Cl. H02K 3/02; H02K 17/04; H02K 3/28

(52) U.S. Cl. CPC H02K 3/02; H02K 3/28; H02K 17/04

(57) ABSTRACT

A single-phase induction motor includes a stator including a main winding with a first coil (P1a), a second coil (P1b), a third coil (P2a) and a fourth coil (P2b). The first coil and the third coil are manufactured from a first conductive material (2), the second coil and the fourth coil are manufactured from a second conductive material (3), with resistivity other than that of the first conductive material. The first coil and the second coil are arranged at one of the stator poles (P1) and the third coil and the fourth coil are arranged at the opposite pole (P2). The first coil and the fourth coil are electrically connected through a series connection, configuring a first branch (R1). The second coil (P1b) and the third coil (P2a) are electrically connected through a connection in series, configuring a second branch (R2).

The present invention relates to a single-phase induction motor provided with a hybrid winding. The single-phase induction motor being used on hermetic cooling compressors.

### DESCRIPTION OF THE PRIOR ART

A single-phase induction motor is the type of engine most used in household cooling applications (refrigerators, freezers, and air-conditioners), being further used in various applications such as washing or drying machines, fans and pumps. Single-phase induction motors have the advantage that they can be connected to the phase voltage of electrical networks, usually available in residences and small rural properties, unlike three-phase motors. Additionally, this type of motor comprises two windings arranged on the stator, one of which is the main winding and the other is the auxiliary winding (or starting winding), the auxiliary winding having, as its main function, generating the turning field of the single-phase induction motor.

The single-phase induction motors known from the prior art have, in most cases, the main winding and auxiliary winding manufactured from copper, having excellent thermal and electrical properties, being an excellent electrical conductor, thus having low electric resistivity (on the order of 1.673×10⁻⁶ ohm·cm at 20° C.

The copper's application is not limited to the use on windings of single-phase induction motors, due to its efficiency, resistance and reliability, copper is the most used metal in any type of applications in which electrical or thermal conductivity is present. This is due to the fact that copper has excellent electric conductivity, is compatible with electric connectors and other devices and is easy to handle, which makes the installation easier. Additionally, copper meets the electrical specifications of most countries.

However, copper has the disadvantage that its cost has been increasing drastically in the last few years, and this factor has led manufacturers of single-phase induction motors to study other options of electric conductors. One of the options found was the use of aluminum in the single phase induction motor windings. Despite having 60% of the electric conductivity of copper, the use of aluminum windings on the stator proves to be advantageous in terms of cost, since aluminum is cheaper than copper. Besides, the density of aluminum, being approximately 1/3 of the copper density, reduces the weight of the windings (for a given resistance of the coils).

Some single-phase induction motors known from the state of art use aluminum windings, aluminum being used in the manufacture of both the main winding and the auxiliary winding. Additionally, it is known from the state of art single-phase induction motors that uses a combination of two types of conductors for manufacturing the stator windings.

As an example, one can mention patent U.S. Pat. No. 7,772,737, which describes an electric motor which the stator windings are formed by a first electric conductor and by a second electric conductor, the first and second electric conductors being connected in parallel and manufactured from copper and aluminum, respectively. Further, the US patent describes that the motor has another winding provided with a third electric conductor and with a fourth electric conductor, these being also connected in parallel.

The motor described in patent U.S. Pat. No. 7,772,737 has the disadvantage that the current flow in the motor windings is not uniform, providing non-homogeneous heating of the motor and harmonic torques generation, which may cause undesirable noises and vibrations.

Further, four combinations are known regarding the type of conductor used for making the windings of a single-phase induction motor known from the prior art.

The first configuration would be the manufacture of the main winding and of the auxiliary winding from copper, this configuration is used on high-efficiency and/or high power-density motors and has a high manufacture cost. The second configuration makes use of the main winding made of copper and of the auxiliary winding made of aluminum, this configuration is used when it is possible to replace a small part of the total volume of copper by aluminum conductors. On the other hand, the third configuration is used when there is the possibility of replacing most of the total volume of copper by aluminum conductors, and this configuration consists in manufacturing the main winding from aluminum and the auxiliary winding from copper. The fourth and last configuration known from the prior art makes use of the main and auxiliary winding made of aluminum, this configuration being used on motors that do not require high efficiency and/or high power-density.

### DESCRIPTION OF THE PRIOR ART BASED ON THE DRAWINGS

FIG. 1 illustrates the four electric embodiments of the windings of a single-phase induction motor known from the prior art. Such prior-art motors, as already mentioned, have the main winding and the auxiliary winding manufactured using a single conductive material (copper or aluminum) or have the main winding manufactured from copper (or aluminum) and the auxiliary winding manufactured from aluminum (or copper). It is noted that the single-phase induction motors known from the prior art do not have copper and aluminum conductors on the same winding, as proposed by the present invention. The only known exception would be patent U.S. Pat. No. 7,772,737, however, this patent suggests that each branch of each winding should be formed by only one type of material, which would impair the operation of the motor, as already described before.

FIG. 1(a) shows the first embodiment of the windings of a single-phase induction motor known from the prior art, as can be observed, this motor has coils arranged at one of the poles P1 of the stator and coils arranged at the opposite pole P2 of the stator, wherein the first coil P1a, the second coil P1b, the third coil P2a and the fourth coil P2b are composed of a first conductive material, in this case copper. Additionally, the auxiliary winding A also comprises a fifth coil A1 and a sixth coil A2 manufactured from copper. This type of configuration is used on high-efficiency motors and has a high manufacture cost.

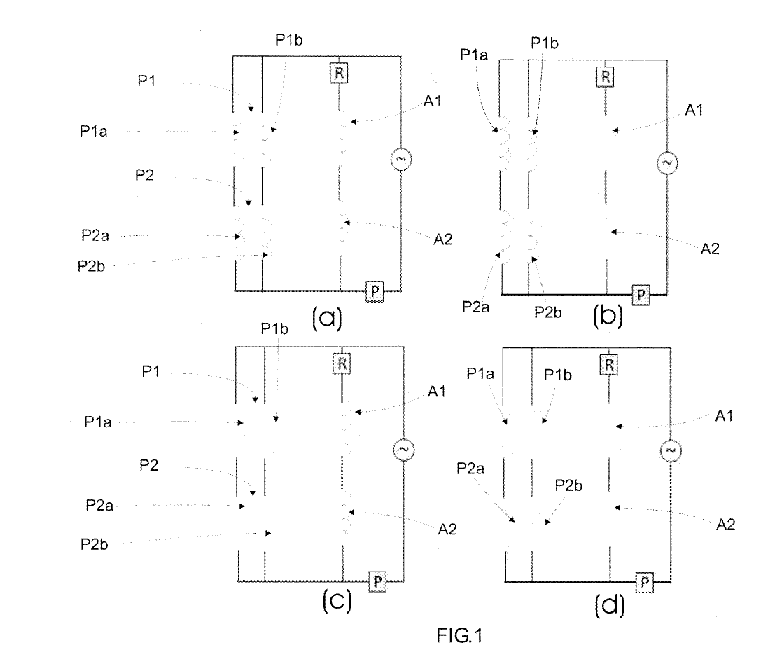

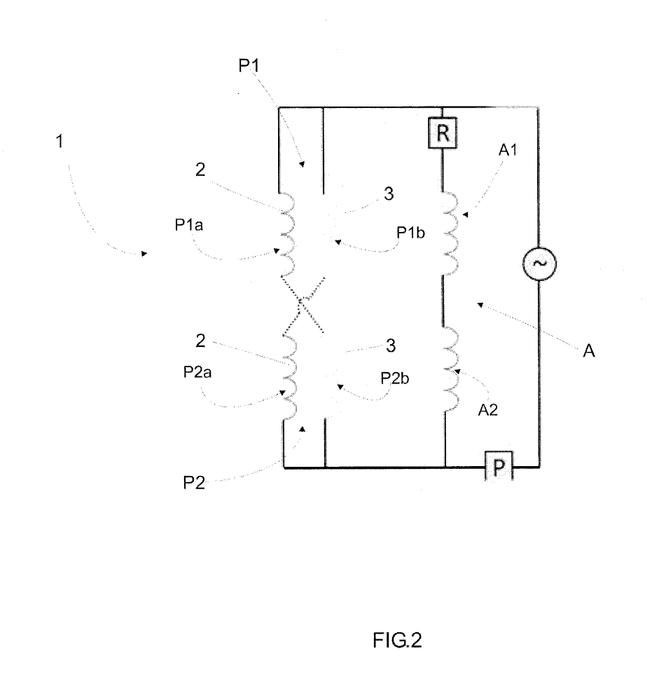

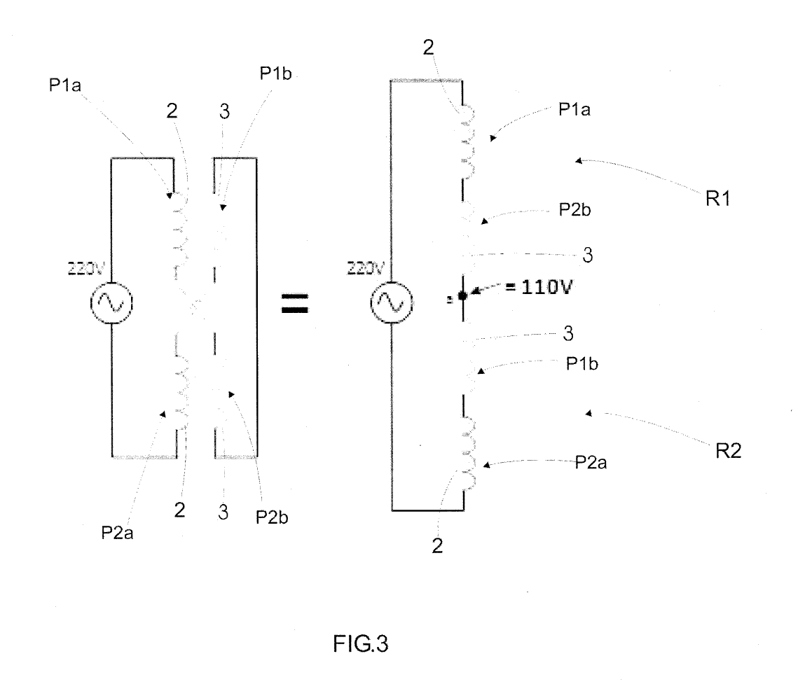

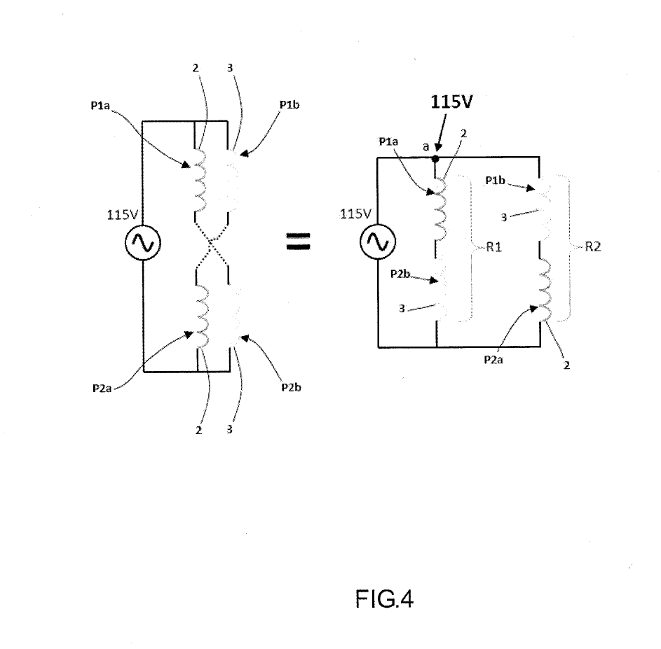

As an alternative to the high manufacture cost of the configuration shown in FIG. 1(a), one show in FIG. 1(b) the configuration of the windings on which the coils located at pole P1 and the coils located at the opposite pole P2 continue to be manufactured from copper. However, in this configuration the auxiliary winding A of the induction motor is manufactured from aluminum. Such a configuration has a slightly lower manufacture cost as compared with the manufacture cost of the configuration shown in FIG. 1(b).

Another possible configuration known from the prior art, is the configuration of the windings shown in FIG. 1(c). This configuration has the coils located at the pole P1 and the coils located at the opposite pole P2 manufactured from aluminum, on the other hand, the auxiliary winding A has its coils A1 and A2 manufactured from copper. In terms of cost, this configuration has a lower manufacture cost as compared with the manufacture cost of the configuration shown in FIG. 1(b).

FIG. 1(d) shows the configuration in which all the windings (coils located at the pole P1 and the coils located at the opposite pole P2 and coils of the auxiliary winding A) of the single-phase induction motor are manufactured from aluminum,. In terms of cost, this configuration is the one that has the lowest manufacture cost. However, considering that the coils of the main winding comprise 75% of the total volume of the electric conductors present on the motor winding, the number of motors which it is possible to use the configurations shown in FIGS. 1(c) and 1(d) is very small, since the use of aluminum is limited by the filling factor (ratio between the area occupied by the windings and the maximum area available for arranging them) of the single-phase induction motors.

As shown above, although the use of the largest possible amount of aluminum is always advantageous, the use of this type of conductor is limited by the filling factor, and when it is not possible to increase the slots area of the blade, a part of the conductors should remain as copper. The ideal balance of copper and aluminum also depends on other variables, as for instance the outer diameter of the stator, this occurs because the increase in slots for receiving the aluminum windings would require a larger outer diameter. In this case, one should calculate the cost of the increment in the total amount of steel, taking into account the increase in the slots for receiving the aluminum windings.

Among the four configurations known from the prior art and mentioned above, the fourth configuration (main winding and auxiliary winding made from aluminum) is the one that has the lowest cost. However, and as already mentioned, since the main winding is responsible for up to 75% of the total volume of the conductor, the number of motors on which it is possible to use this configuration is very small. So, in most cases it is not possible to use aluminum for manufacturing the main winding, just due to the limitations of filling the slots.

With a view to potentiate the use of aluminum on the prior-art induction motors, the present invention makes use of a single-phase induction motor provided with a hybrid winding, such hybrid winding comprising aluminum conductors in conjunction with copper conductors on the same winding branch, potentiating the applicability of aluminum on single-phase induction motors, thus reducing the total manufacture cost of the motor.

Further, the present invention makes use of single-phase induction motors provided with hybrid windings, such motors may be sized so as to be fed electrically by nominal voltage values of 115-127 VAC or 220-140 VAC.

Further, the present invention makes use of single-phase induction motors provided with hybrid windings, such motors may be sized to be used on bivolt motors, so that the same motor can be fed electrically by nominal voltage values of 115-127 VAC or 220-140 VAC.

### OBJECTIVES OF THE INVENTION

The present application has the objective of providing a single-phase induction motor provided with hybrid windings.

Another objective of the present invention is to provide a single-phase induction motor provided with a hybrid winding and that can be fed by nominal voltage values of 115-127 VAC or 220-240 VAC.

It is also an objective of the present invention to provide a single-phase induction motor on which the current density on the branches and on the coils of the motor windings is homogeneous.

Finally, it is an objective of the present invention to provide a single phase induction motor that enables the use of an aluminum coil with a number of turns different from the number of turns of the copper coil, without causing unbalance of current flow or generating harmonic torques or even problems of heating or vibrations.

### BRIEF DESCRIPTION OF THE INVENTION

The objectives of the invention are achieved by providing a single-phase induction motor comprising a stator, the stator comprising a winding with a first coil P1a, a second coil P1b, a third coil P2a and a fourth coil P2b. The first coil P1a and the third coil P2a are manufactured from a first conductive material 2. The second coil P1b and the fourth coil P2b are manufactured from a second conductive material 3, with resistivity different from the first conductive material 2. The single-phase induction motor is configured so that the first coil P1a and the second coil P1b are arranged at one of the poles P1 of the stator. The third coil P2a and the fourth coil P2b are arranged at the pole P2 opposite that of the first coil P1a and of the second coil P1b. The first coil P1a and the fourth coil P2b are electrically connected in series, configuring a first branch (R1). The second coil P1b and the third coil P2a are electrically connected through a connection in series, configuring a second branch R2.

### BRIEF DESCRIPTION OF THE DRAWINGS

The present invention will now be described in greater detail with reference to the attached drawings, in which:

FIG. 1 illustrates the electric connections of a single-phase induction motor known from the state of art;

FIG. 2 is a representation of the electric connection of a single-phase induction motor as proposed in the present invention;

FIG. 3 is a representation of the electric connection of one of the single-phase induction motor windings as proposed by the present invention with the series connection of the R1 and R2 branches.

FIG. 4 is a representation of the electric connection of one of the single-phase induction motor windings as proposed by the present invention with the parallel connection of the R1 and R2 branches.

### DETAILED DESCRIPTION OF THE INVENTION

As can be observed in FIG. 2, one represents a preferred electrical connection of the single-phase induction motor provided with a stator as proposed in the present invention. Such a single-phase induction motor comprises a main winding with fourth coils, a first coil P1a, a second coil P1b, a third coil P2a and a fourth coil P2b, wherein the first coil P1a and the third coil P2a are preferably manufactured from a first conductive material 2, this material being copper. On the other hand, the second coil P1b and the fourth coil P2b are preferably manufactured from a second conductive material 3, this material being aluminum.

The main winding is configured so that the first coil P1a and the second coil P1b are at one of the poles P1 of the stator, and the third coil P2a and the fourth coil P2b are at the opposite pole P2 of the stator. The electric connection in series of the first coil P1a and of the fourth coil P2b configures a first branch R1 of the single-phase induction motor of the present invention. On the other hand, the electric connection in series of the second coil P1b and of the third coil P2a configures a second branch R2. Such form of electric connection of the coils of the branches R1 and R2 configures a hybrid crossed connection of the induction motor described in the present invention and shown in FIG. 2.

Further, the single-phase induction motor proposed in the present invention guarantees the balance of the inductances and resistances and, as a result, guarantees that the current in the motor winding will be the same one. Additionally, the single-phase induction motor enables the use of a coil made of aluminum with a number of turns different than the number of turns of the copper coil, without causing unbalance of current flow or generating harmonic torques.

As can be better observed in FIG. 2, the single-phase induction motor further comprises an auxiliary winding A. In this preferred embodiment, the auxiliary winding A comprises a fifth coil A1 and a sixth coil A2 electrically connected in series and manufactured from the same material. It should be pointed out that, in an additional embodiment of the present single-phase induction motor, the auxiliary winding A might have the fifth coil A1 manufactured from copper and the sixth coil A2 manufactured from aluminum, or vice-versa.

Additionally, present embodiment can be used for constructing bivolt single-phase induction motors, that is, configured to be fed electrically by nominal voltage values of 115-127 VAC or 220-240 VAC, without the need to alter the number of turns or the diameter of the wires. In this case, for the higher nominal voltage (220-240 VAC), one should connect the branches R1 and R2 electrically in series, as shown in FIG. 3. On the other hand, for the lower nominal voltage (115-127 VAC), one should connect them in parallel, as shown in FIG. 4.

FIG. 3 shows the scheme of electrical connections that should be carried out in the case of nominal voltage in the range 220-240 VAC. As can be observed, the branch R1, comprising the first coil P1a and by the fourth coil P2b, is electrically connected in series with the branch R2, comprising the second coil P1b and by the third coil P2a. In this preferred example of the induction motor, the first coil P1a and the third coil P2a are manufactured from a first material 2, this material being copper. On the other hand, the second coil P1b and the fourth coil P2b are manufactured from a second material 3, this material being aluminum.

In the case of feeding with nominal voltage in the range of 220-240 VAC, the connection of the branches R1 and R2 in series enable the balance of voltage between such branches, dividing the voltage exactly by half.

FIG. 4 shows the scheme of electric connections that should be carried out in the case of nominal voltage in the range of 115-127 VAC. As can be observed, the branch R1, comprising the first coil P1a and the fourth coil P2b, is electrically connected in parallel with the branch R2, comprising the second coil P1b and the third coil P2a. The first coil P1a and the third coil P2a are manufactured from copper and the coils P1b and P2b are manufactured from aluminum.

A preferred example of embodiment having been described, one should understand that the scope of the present invention embraces other possible variations, being limited only by the contents of the accompanying claims, which include the possible equivalents.

1.-16. (canceled)

17. A single-phase induction motor comprising:
a stator, the stator comprising a main winding with a first coil (P1a), a second coil (P1b), a third coil (P2a) and a fourth coil (P2b), wherein:
the first coil (P1a) and the third coil (P2a) are manufactured from a first conductive material (2),
the second coil (P1b) and the fourth coil (P2b) are manufactured from a second conductive material (3), with resistivity other than that of the first conductive material (2),
the first coil (P1a) and the second coil (P1b) are arranged at one of the stator poles (P1),
the third coil (P2a) and the fourth coil (P2b) are arranged at the pole (P2) opposite that of the first coil (P1a) and of the second coil (P1b),
the first coil (P1a) and the second coil (P1b) comprise a number of turns equal to the number of turns of the third coil (P2a) and of the fourth coil (P2b),
the first coil (P1a) and the fourth coil (P2b) are electrically connected to each other through a series connection, configuring a first branch (R1), the second coil (P1b) and the third coil (P2a) are electrically connected through a connection in series, configuring a second branch (R2).

18. The single-phase induction motor according to claim 17, further comprising:
an auxiliary winding (A) provided with a fifth coil (A1) and a sixth coil (A2);
wherein the first branch (R1) of the main winding is connected electrically in series with the second branch (R2).

19. The single-phase induction motor according to claim 17, further comprising:
an auxiliary winding (A) provided with a fifth coil (A1) and a sixth coil (A2);
wherein the first branch (R1) of the main winding is connected electrically in parallel with the second branch (R2).

20. The single-phase induction motor according to claim 18, wherein the auxiliary winding (A) is configured with the fifth coil (A1) and the sixth coil (A2) connected electrically in series and manufactured from the same conductive material.

21. The single-phase induction motor according to claim 18, wherein the auxiliary winding (A) is configured with the fifth coil (A1) and the sixth coil (A2) connected electrically in series, the fifth coil (A1) being manufactured from the first conductive material (2) and the sixth coil (A2) being manufactured from the second conductive material (3).

22. The single-phase induction motor according to claim 17, wherein said motor is configured for bivolt applications, by switching the electric connections of the branches (R1) and (R2) either in series or in parallel.

23. The single-phase induction motor according to claim 17, wherein the first conductive material (2) is copper and the second conductive material (3) is aluminum.

24. The single-phase induction motor according to claim 17, wherein the first conductive material (2) is aluminum and the second conductive material (3) is copper.

25. The single-phase induction motor according to claim 19, wherein the auxiliary winding (A) is configured with the fifth coil (A1) and the sixth coil (A2) connected electrically in series and manufactured from the same conductive material.

26. The single-phase induction motor according to claim 19, wherein the auxiliary winding (A) is configured with the fifth coil (A1) and the sixth coil (A2) connected electrically in series, the fifth coil (A1) being manufactured from the first conductive material (2) and the sixth coil (A2) being manufactured from the second conductive material (3).

27. The single-phase induction motor according to claim 18, wherein said motor is configured for bivolt applications, by switching the electric connections of the branches (R1) and (R2) either in series or in parallel.

28. The single-phase induction motor according to claim 19, wherein said motor is configured for bivolt applications, by switching the electric connections of the branches (R1) and (R2) either in series or in parallel.

29. The single-phase induction motor according to claim 20, wherein said motor is configured for bivolt applications, by switching the electric connections of the branches (R1) and (R2) either in series or in parallel.

30. The single-phase induction motor according to claim 21, wherein said motor is configured for bivolt applications, by switching the electric connections of the branches (R1) and (R2) either in series or in parallel.

31. The single-phase induction motor according to claim 18, wherein the first conductive material (2) is copper and the second conductive material (3) is aluminum.

32. The single-phase induction motor according to claim 19, wherein the first conductive material (2) is copper and the second conductive material (3) is aluminum.

33. The single-phase induction motor according to claim 20, wherein the first conductive material (2) is copper and the second conductive material (3) is aluminum.

34. The single-phase induction motor according to claim 18, wherein the first conductive material (2) is aluminum and the second conductive material (3) is copper.

35. The single-phase induction motor according to claim 19, wherein the first conductive material (2) is aluminum and the second conductive material (3) is copper.

36. The single-phase induction motor according to claim 20, wherein the first conductive material (2) is aluminum and the second conductive material (3) is copper.
